(19) United States
(12) Patent Application Publication
(10) Pub. No.: US 2003/0084580 A1
(43) Pub. Date: May 8, 2003

(54) Horizon attitude direction indicator

(76) Inventor: Michael Hughes, Oklahoma City, OK (US)

Correspondence Address: R. William Graham, 3340 Rosewood Lane, Oklahoma City, OK, 73120, US

(21) Appl. No.: 10/006,352

(22) Filed: Nov. 8, 2001

(51) Int. Cl. G01C 9/18

(52) U.S. Cl. 33/333

(57) ABSTRACT

The horizon attitude direction indicator includes a container having defined volume and at least one translucent surface portion, wherein said translucent portion includes a marking thereon indicating horizon, a first liquid of a first density occupying substantially one half volume of the container, a second liquid of a second density different from the first density occupying substantially one half volume of the container, and wherein the first liquid and the second liquid are substantially immiscible and the translucent portion is disposed in a manner to permit visual inspection of the liquids therein.

### FIELD OF THE INVENTION

The present invention relates generally to devices used for determining horizon attitude typically for a vehicle. More particularly, the present invention relates to a horizon attitude direction indicator (HADI) for use with a vehicle such as an aircraft.

### BACKGROUND OF THE INVENTION

An overwhelming percent of tactical aircraft fatalities occur due to impact with the ground during low altitude maneuvering. This is particularly so with night flights and flight over water, wherein the pilot literally flew the aircraft into the ground or water. Controlled flight into the ground during approach and departure account for the majority of all fatal spatial disorientation mishaps. Fatal spatial disorientation mishaps in all types of aviation (military, civil and commercial) have remained at a relatively constant percent since accident statistics have been kept. These aircraft accidents continue to occur despite sophisticated ground proximity detection devices.

The prior art includes various aircraft flight control instruments and displays. For example, there exist ground proximity detection devices, i.e., an altimeter that may be coupled with a vertical descent speed measuring device. These ground proximity warning devices when combined with a pilot selected threshold altitude and a visual and/or audio warning. When the aircraft descends below the selected threshold altitude, a warning is generated. There have been very few documented incidents of altimeter or ground proximity warning device failure. There have been many incidents of controlled flight into the ground with working ground proximity warning devices.

The possibilities that account for controlled flight into the ground include pilot error or insufficient time from the warning device to ground impact for the pilot to react. Current ground proximity indicators present their warning via several methods or combinations of methods. These include: analog AGL altitude displays; digital AGL altitude displays; altitude warning tones; prerecorded voice warning, e.g., “altitude” or “pull-up”; instrument panel warning lights; and visual warning symbols, e.g., a flashing “X” in the Head Up Display (HUD).

Another concern with respect to preventing fatal spatial disorientation mishaps is the ability of the pilot to determine the current attitude, i.e., the orientation of the aircraft relative to a horizon, and to correct the attitude of the aircraft to prevent a controlled flight into the ground. Peripheral Vision Horizon Displays (PVHDs) were designed to assist in determining the attitude of an aircraft. These PVHDs were developed in the early 1980s and include electromechanical devices to project the horizon on the front instrument panel of the cockpit. The artificial horizon simulates aircraft pitch and roll by drawing the artificial horizon with respect to a vertical or horizontal line. Other devices provide attitude information to a pilot via a helmet.

Such flight control displays, which may be of the panel mounted variety or of the head up display (HUD) variety, are commonly found in commercial, military, and civilian aircraft. The attitude display instrument is referred to herein as a horizon attitude direction indicator (HADI). A HADI typically indicates a reference point or line, e.g., a representative horizon line, relative to the position of the aircraft in which it is disposed. The aircraft may be represented by a fixed element of the HADI display; such as the aircraft wings as one or more horizontal marks that are centered with respect to the display screen.

Some devices show the horizon line rendered on the HADI display to move up and down in response to changes in the pitch of the aircraft. This type would also show the horizon line to rotate in response to changes in the roll of the aircraft.

Some conventional HADIs include a blue colored portion above the horizon line (representing the sky) and a brown or tan colored portion below the horizon line (representing the Earth). This color scheme is employed to enable pilots to determine the attitude of the aircraft at any given moment. Such scheme's have been criticized for their lack of clarity or ease of use in some cases, particularly when used as a primary instrument.

HADIs and other related instrumentation may display alphanumeric or graphical information related to the direction of the aircraft relative to a specific reference point such as the horizon. However, the manner in which such information is typically displayed requires the pilot to scan the instrumentation panel (or HUD field), locate the displayed information, and interpret the information. Depending upon the current flight conditions, it may be difficult for a pilot to quickly and easily locate and digest such information. Consequently, the reaction time associated with adjusting the direction of the aircraft toward the reference point may be undesirably long.

One common flaw of the prior art is that they are subject to electrical and/or mechanical failure. Another problem with HADIs is that they are relatively expensive to manufacture. With this said, there is a need to improve HADI's and it is the aim of the invention to provide a HADI having features that address the above shortcomings of the prior art. The present invention provides an improved HADI.

### BRIEF SUMMARY OF THE INVENTION

It is an object to improve HADIs.

It is another object to provide a HADI which is substantially less susceptible to mechanical or electrical failure.

It is an object to provide a back-up HADI.

It is another object to simplify the manufacture of HADIs.

Accordingly, the present invention is directed to an improved horizon attitude direction indicator (HADI). The horizon attitude direction indicator includes a container having defined volume and at least one translucent surface portion, wherein said translucent portion includes a marking thereon indicating horizon, a first liquid of a first density occupying substantially one half volume of the container, a second liquid of a second density different from the first density occupying substantially one half volume of the container, and wherein the first liquid and the second liquid are substantially immiscible and the translucent portion is disposed in a manner to permit visual inspection of the liquids therein. Preferably, the container is transparent. Further, the transparent portion includes a second marking indicating an upright position of the HADI. The liquids are preferably of a different color.

### BRIEF DESCRIPTION OF THE DRAWINGS

A more complete understanding of the present invention may be obtained by referring to the detailed description and claims when considered in connection with the following illustrative Figures, wherein like reference numbers refer to similar elements throughout the Figures and:

FIG. 1 is a perspective view of a HADI device of the present invention;

FIG. 2a is a side view of the HADI device of the present invention at a level or horizontal position;

FIG. 2b is an end view of the HADI device of the present invention at a level or horizontal position

FIG. 3a is a side view of the HADI device of the present invention at an inclined position;

FIG. 3b is an end view of the HADI device of the present invention at an inclined position;

FIG. 4a is a side view of the HADI device of the present invention at a declined position;

FIG. 4b is an end view of the HADI device of the present invention at a declined position;

### DETAILED DESCRIPTION OF A PREFERRED EMBODIMENT

Referring now to the drawings, the present invention is generally represented by the numeral 10. It should be appreciated that such functional components shown may be realized by any number of hardware components configured to perform the specified functions. In addition, those skilled in the art will appreciate that the present invention may be practiced in conjunction with any number of vehicular instrumentation systems and that the aircraft flight system described herein is merely one exemplary application for the invention.

It should be appreciated that the particular implementations shown and described herein are illustrative of the invention and its best mode and are not intended to otherwise limit the scope of the present invention in any way. Furthermore, the HADI figures shown are illustrative in nature and are not intended to limit the scope or applicability of the present invention in any way.

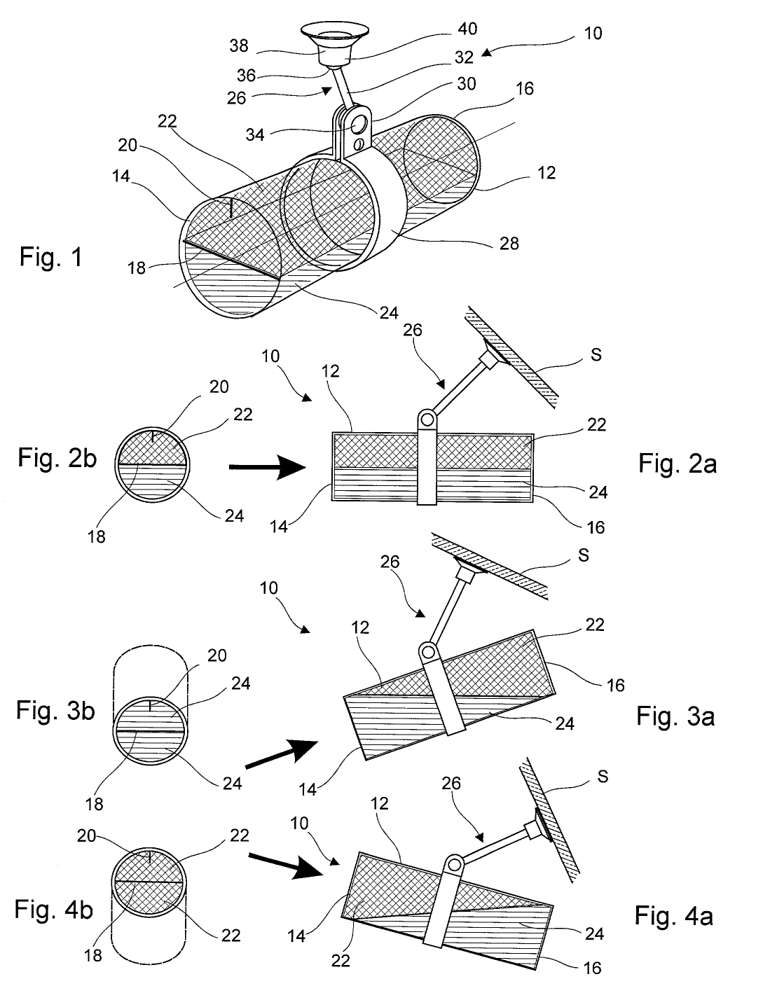

Referring now to FIG. 1, the HADI device 10 includes a container 12 which is by way of example shown to be a cylinder. The container 12 is preferably transparent, in at least a first end 14. The container 12 also includes a second end 16. The size and shape of the container 12 can vary so long as the principles set forth herein to carry out the invention are maintained.

The first end 14 and second end 16 are generally circular. The first end 14 includes a horizontal marking 18 which can be formed into the surface of the end 14 and can include an upper marking 20 indicating an upright orientation of the device 10. The horizontal marking 18 preferably, by way of example, traverses midway across the face of the first end 14 and serves a horizon marking for a normally positioned device as seen in FIGS. 2a and 2b. The upper marking includes a vertical line which runs vertically midway through the face of the end 14 and serves to indicate a normally upright position of the device 10.

A key aspect of the invention includes two immiscible fluids 22 and 24 within the container 12. Here, the fluids 22 and 24 preferably include a relatively low freezing point either inherently and/or by way of additives to lower the respective freezing points for cold weather applications. The immiscible or polar solutions are thus naturally precluded from mixing. Also, critical to the invention is that one of the fluids has a greater density, i.e., heavier, thus always tending to position closer to the earth due to gravitational forces of the earth than the other fluid. Here, fluid 24 is shown to have as the heavier fluid and thus occupies a bottom volumetric portion of the container 12. Preferably, the fluids 22 and 24 each occupy substantially one half of the volume within the container 12. It is contemplated that various types of fluids can be employed to carry out the invention, and might include a gas so long as the function of the invention is enabled.

The fluid 24 can include a dye, for example, a blue dye color, whereas the fluid 22 can include a contrasting dye, for example, a yellow dye. The particular color dyes can be selected to achieve the best contrast and therefore those mentioned herein are only illustrative of the invention. For example, the fluids 22 and 24 can also include a chemi-luminescent material, for example, phosphorescence, fluorescence, which aid in contrasting the fluids 22 and 24. It is also contemplated that an external light source can be directed at the device 10 in a manner to illuminate the fluids 22 and 24 and aid contrast.

A removable mounting connector 26 is provided for removably connecting the device 10 to a surface S. The surface S can be, for example, a windshield, inside of a cockpit. The removable mounting device 26 can take on various forms in order to facilitate the use of the invention and is not intended to be limiting of the scope of the invention. The removable mounting connector 26 includes a clamp 28 which can fixably retain the container 12. The clamp 28 includes a joint 30 to which a support arm 32 is movably positionably connected at one end 34. Another end 36 of the support arm 32 is movably positionably connected to a suction cup element 38 having a neck 40 to receive the end 36. The ends 34 and 36 can be frictionally connected so that the device 10 can be positioned as desired in a relatively secure manner. It is contemplated that other configurations and modifications may be made without departing from the invention. For example, additional locking mechanisms may be desirable at the connections to secure the device 10 in a desired position.

The liquids 22 and 24 can be introduced into the container 12 in several ways. For example, one end 16 can remain open until the liquids 22 and 24 are filled and then subsequently sealably connected to the container 12. In this regard, while not shown, the end 16 and container 12 can be formed with a threaded surface portions to connect to one another, be chemically bonded to one another, or optionally the container 12 could be formed in one piece with the ends 14 and 16 thereto and have a port and sealing cap (not shown) for filling the liquids 22 and 24.

As seen in the drawings, the device 10 provides a substantially infallible HADI which is not susceptible to mechanical failure as is the case with existing HADI'S. Moreover, the invention provides a pilot with a relatively inexpensive HADI which he/she can take and affix to any plane or vehicle. Indeed, the invention can have submarine applications.

The present invention has been described above with reference to a preferred embodiment. The drawings illustrate the use of the invention in a level horizontal, inclined and declined position, but it will be apparent to those skilled in the art that the invention will also work to show the roll of the plane, for example, and the use of the upper marking 20 in conjunction with the horizontal marking 18 are useful in this regard. However, those skilled in the art having read this disclosure will recognize that changes and modifications may be made to the preferred embodiment without departing from the scope of the present invention. These and other changes or modifications are intended to be included within the scope of the present invention, as expressed in the following claims.

What is the claimed is:

1. A horizon attitude direction indicator (HADI) for displaying the position of a vehicle, said HADI comprising:
a container having defined volume and at least one translucent surface portion, wherein said translucent portion includes a marking thereon indicating horizon;
a first liquid of a first density occupying a predetermined portion of said volume of said container;
a second liquid of a second density different from said first density occupying substantially a remainder of said volume of said container; and
wherein said first liquid and said second liquid are substantially immiscible and said translucent portion is disposed in a manner to permit visual inspection of said liquids therein.

2. The HADI of claim 1, wherein said predefined portion is substantially one half of said volume.

3. The HADI of claim 1, wherein said marking is a generally horizontal line.

4. The HADI of claim 1, wherein said transparent portion includes a second marking indicating an upright position of said HADI.

5. The HADI of claim 1, wherein said container is transparent.

6. The HADI of claim 1, wherein said liquids are of a different color.

7. The HADI of claim 1, which further includes means for connecting said container to a surface of the vehicle.

8. The HADI of claim 7, wherein said connecting means includes means for removable connecting said container to said surface.
